(19) United States
(12) Patent Application Publication
(10) Pub. No.: US 2024/0002676 A1
(43) Pub. Date: Jan. 4, 2024

(54) MARINE COATING COMPOSITION

(71) Applicant: BAE SYSTEMS plc, London (GB)

(72) Inventor: Madan Pal, Portsmouth Hampshire (GB)

(73) Assignee: BAE SYSTEMS plc, London (GB)

(21) Appl. No.: 18/252,600

(22) PCT Filed: Nov. 4, 2021
(86) PCT No.: PCT/GB2021/052871

§ 371 Date: May 11, 2023

(30) Foreign Application Priority Data
Nov. 12, 2020 (GB) 2017828.1

(51) Int. Cl. C09D 5/16; C09D 7/61; C09D 7/40

(52) U.S. Cl. CPC C09D 5/1618; C09D 7/69; C09D 7/68; C09D 7/61

(57) ABSTRACT

The invention relates to an anti-corrosion and anti-fouling composition, particularly to a protective composition for a marine body, wherein in said composition comprises a copper alloy of the form Cu(M*), wherein M* is at least one metal which is more electronegative than copper, wherein said composition comprises ceramic filler particles in the range of from 0.1 to 20 wt %.

This invention relates to compositions, their preparation and use. In particular, the invention relates to metal-bonded compositions.

A range of solutions such as cathodic protection in the form of impressed current and sacrificial anodes, various forms of surface engineering, compositions and treatments are used to mitigate corrosion in marine environments.

Maintaining a sound material-state is paramount to ensuring operational readiness and prolonging the service life of naval ships. The current state-of-the-art practice is to preserve ships by applying specialist paint compositions. However, the protection offered by paint compositions is often limited due to their inherent limitations, such as: heterogeneity, permeability, and low damage tolerance against mechanical wear.

According to a first aspect of the invention there is provided a protective composition for a marine body, wherein said composition comprises a copper alloy of the form Cu(M*), wherein M* is at least one metal, which is more electronegative than copper, wherein said composition comprises reinforced filler particles in the range of from 0.1 to 20 wt %; preferably the reinforced filler particles may be ceramic filler particles in the range of from 0.1 to 20 wt %.

The electronegative nature is with respect to the seawater galvanic series.

A marine body may be any engineering platform such as, for example boat, ship, rib, jetty, harbours, oil platforms, pipes, cables, buoys, etc. exposed to a marine environment, typically said environment comprising seawater, sea-spray or salt laden air.

The marine body may be manufactured from metals or metal alloys, especially ferrous alloys, further the material may also be manufactured from composites (such as for example the hull of a rib), concrete, polymers, wood, etc.

M* may be selected from any metal and/or alloy with standard electrode potential less than Cu, preferably the M* has an electrode potential less than +0.35 V, more preferably less than +0.1V, preferably in the range of from −0.1 V to −3.1 V.

In a preferred arrangement M* may be silver, copper, antimony, iron, lead, tin, nickel, cobalt, chromium, cadmium, zinc, manganese, aluminium, beryllium, magnesium, sodium, barium, calcium, potassium, rubidium, lithium, or their alloys, more preferably tin, zinc, iron, cadmium, aluminium, beryllium, magnesium and their alloys.

The ratio of Cu to M* may be independently selected, preferably Cu may be in a greater wt % than (M*) wt %.

The metal (M*) may be present in less than 55% wt in the composition, with Cu and ceramic making up 100 wt %. Preferably M* is less than 40 wt %, preferably in the range of from 0.1 wt % to 35 wt %. The use of less than 40 wt % M* has been shown to maximise the formation of a intermetallic in the composition.

TABLE 1
a list of typical intermetallics formed in brass alloys

| Intermetallic | Cu | Zn | Common phases |
|---|---|---|---|
| Type | wt. % | wt. % | CuₓZn_{y} (ₓ & _{y} in wt %) |
| α | >65 | <35 | Cu₉₅Zn₅, Cu₈₈Zn₁₂, Cu₈₅Zn₁₅, |
| | | | Cu₇₅Zn₂₅, Cu₇₀Zn₃₀, Cu₆₆Zn₃₄ |
| α-β | 55-65 | 35-45 | Cu₆₃Zn₃₇, Cu₆₀Zn₄₀, Cu₅₈Zn₄₂, |
| | | | Cu₅₅Zn₄₅ |
| β | 50-55 | 45-50 | Cu₅₂Zn₄₈, Cu₅₀Zn₅₀, Cu₅₅Zn₄₅ |
| γ, ε, η | <50 | >50 | Cu₃₇Zn₆₃, Cu₁₆Zn₈₄, Cu₂₀Zn₈₀ |
| | | | Cu₂₅Zn₇₅ |

The β phase is less desirable from corrosion point of view, as it is prone to selective dissolution when exposed to a marine environment. Maximising the α phase in the CuM* alloy system also appears to improve the antifouling properties.

However, wear resistance may be increased with the presence of more β phase and other phases, as listed above.

The use of α phase in combination with the reinforced particles, especially ceramic filler particles, increases the wear resistance and retains the antifouling anti corrosion of the a phase.

The zinc and copper are not present as separate constituents but as α and β solid solutions. The effect of corrosion is that one constituent of the alloys M*, such as for example zinc is selectively removed leaving the copper behind.

Without being bound by theory, the mechanism by which this occurs is probably the zinc being selectively leached out from the brass, the zinc and copper both pass into solution together, but the copper is then almost immediately redeposited in virtually the same position that it occupied originally. The result therefore is to remove the zinc as corrosion products and leave a residue of copper, which retains the original shape and dimensions of the deposited metal composition before corrosion, but the residue is porous and has very little strength. The use of reinforced filler particles provides the composition when applied as a coating with the strength to withstand the marine environment.

The reinforced filler particles may be selected from any inert filler particles, that is inert and harder with respect to the CuM* alloy. The Vickers hardness of reinforced fillers particles may be greater than 2 GPa, preferably 5 GPa to 70 GPa.

The reinforced filler particles may be ceramic filler particles or hard carbonaceous particles, such as, for example diamond, carbon nanotubes, graphene. Preferably, the reinforced filler particles may be ceramic filler particles.

The ceramic filler particles may be selected from one or more of metal oxides, borides, carbides, nitrides, sulphates and silicides. The ceramic filler particles may have cubic structures. Preferably the ceramic filler particles may be selected from Al₂O₃, SiC, WC, Si₃N₄, TiO₂, B₄C, ZnO or MgO.

The ceramic filler particles in the composition are present in the range of 0.1% to 20 wt %, more preferably present in the range of from 0.5 to 10 wt %. Whilst high percentage inclusions such as of rom 30-50 wt % may be possible, the composition may not form a uniform coating when applied to a marine body; it may lead to issues of high porosity and cracked surfaces. The use of less than 0.1% of ceramic filler will provide the same anti-fouling, and anti-corrosion effect, however, the composition may not be hard wearing, and may be more readily worn by abrasion and hence limit the usefulness of the composition when applied as coating to a marine body. The narrow range of inclusion of ceramic filler particles has been found to provide the composition with good mechanical and electrochemical material properties, and as such, suitable for use as a coating on a marine body.

The ceramic filler particles may be provided in any size dimension from nano scale particles to mm sized particles, preferably they may have an average longest dimension of 0.1 micron to 50 microns, preferably with a mean distribution range of 20-25 micron.

Whilst ceramic filler particles of 1 mm may be used, they may not be uniformly deposited, such as, for example during cold spraying deposition techniques, their high kinetic energy may cause them to bounce off of the marine body to which they are being applied.

The ceramic filler particles may be of any shape, such as spherical, flake, high aspect ratio elongate particles, irregular shaped, chopped, milled, grounded particles. It has been found that irregular shaped ceramic filler particles are better encapsulated in the composition.

The ceramic filler particles may be a composite, such as for example an inner core of a substrate material coated with a layer of ceramic or vice versa. The inner core substrate material may be a metal, alloy, glass, polymer, and other ceramics. This may allow the materials and physical properties, density of the ceramic filler particles to be selected. Alternatively the ceramic may be part of a mixed metal matrix metal/ceramic and alloy composition.

The composition may be applied to the marine body at thickness of greater than 50 microns, greater than 200 microms, preferably in the range of 50 microns to 1500 microns, more preferably in the range of from 200 microns to 600 microns. It is clear that a sub-micron composition may be applied as a coating or layer to a surface, however it may fail due to the selective dissolution of metal (M*) when exposed to the marine environment, it has been shown that dissolution of Zn, may occur up to a depth of 200 microns. Preferably the composition is applied at a thickness greater than 200 microns.

The composition may be applied in one application at the desired thickness, or built up as a succession of layers to provide a coating. The successive layers may have different composition of Cu(M*) and different percentage inclusion of ceramic particle fillers to present a coating with graded cross-section wherein the coating constituents varies linearly or stepwise from the interface to the outer surface of the said coating.

Optionally there may be an intervening layer between each successive composition layer deposited thereon.

In a further arrangement, there may be an intermediary layer between the marine body and the composition.

The intervening layer and intermediary layers may be independently selected from adhesion promoters or comprise compositions with higher hardness, to improve the wear and mechanical properties of said deposited composition.

The intervening layer and intermediary layers, where present may be Ni, Ag, Al, Sn, Bi, Pb, Cr and alloys thereof, or any commonly used adhesion promoters. Such as for example curable monomers, resins, etc. The intervening layer may be formed by using a post deposition treatment process such shot penning, laser, ultrasonic, heat treatment or annealing etc.

In a further arrangement the alloy may comprise the general formula Cu(M*)(M**) wherein M** is a metal independently selected from the same group of metals and alloys as M*, such that it is a metal which is more electronegative than copper.

The marine body to be coated, may be treated to prepare the surface ready for the composition to be applied. Mechanical and chemical surface cleaning may be used. Chemical techniques may be pickling, such as, for example, acid/alkali etch to promote adhesion between the said composition and the substrate. Mechanical surface preparation may be grit blast, mechanical keying etc.

According to a further aspect of the invention there is provided a marine body, for example a vessel, vehicle or craft, comprising at least one protective composition as defined herein.

The marine body may have at least two independently selected alloys of Cu(M*) in an applied coating, and/or one may be Cu(M*)(M**), as hereinbefore defined.

The protective composition may have a further exterior coating, layer, paint or material applied on top. However, the antifouling properties of the protective composition may not be fully realised.

The protective composition may preferably be provided as the outer-most surface coating on the marine body; this may provide the most beneficial marine body coating providing anticorrosion due to selective dissolution of (M*) and/or (M**), antifouling due to high Cu content within the composition, and further a hard wearing coating due to the inclusion of high Vickers hardness filler material, such as ceramic filler particles.

In a highly preferred arrangement, the marine body may be a boat, ship or rib, comprising a hull, which is in permanent contact with a marine environment, coated with a CuZn alloy wherein said protective composition comprises ceramic filler particles in the range of from 1 to 5 wt %.

According to a further aspect of the invention there is provided the use of a copper alloy of the form Cu(M*), wherein M* is at least one metal, wherein said at least one metal is more electronegative than copper, wherein said composition comprises ceramic filler particles in the range of from 0.1 wt % to 20 wt %, to provide a functional anticorrosion, antifouling and anti-wear composition on a marine body.

According to a further aspect of the invention there is provide a method of applying a Cu(M)* composition, as defined herein to a marine body.

The Cu(M)* alloy composition as hereinbefore defined may be deposited by any suitable methods, such as for example, mechanical, laser cladding, welding, thermal metal spray, cold metal spray, PVD, CVD, electroplate, or electroless deposition.

The method of application preferably comprises the use of cold metal spraying, which offers densely packed compositions, free from oxides and inclusions, and with no practical limit on the overall composition thickness unlike thermal metal spray processes which are typically limited to total thickness' of <0.5 mm. The cold metal spray (CMS) deposition mechanism also results in inclusion of favourable compressive residual stresses in the composition, which may further improve the mechanical properties of the composition when deposited on the marine body. Further, the cold spray system is lightweight and portable so it may be used for in-situ application of compositions. The functional properties of CMS deposited coatings may be tailored by varying the composition of the feedstock powder, or by applying and grading (multiple layers) to form a coating with either a mixture of materials or one or more protective compositions and/or process parameters.

Typically CMS coating techniques require no exclusive health & safety administration, such as hot-permit, removal of insulation/flammable material from behind the substrate, combustible gases or fuels, and enclosed or restricted spaces for the coating deposition operation. This allows greater freedoms of where and when the process may be applied to a marine body.

Typically, CMS coatings are deposited at low temperatures so there is reduced risk of material oxidation resulting in superior mechanical and material properties. The CMS process typically leads to consistency and repeatability of the coating process, and is favourable when compared to thermal spray processes.

In a CMS deposition method, the composition may use separate powders of Cu and M* or it may use a CuM* alloy.

The CMS deposition method allows the co-addition of the ceramic particles in range of 0.3 to 60 wt. %, to provide a composition deposited on the marine body in the range of from 0.1 to 20 wt. %.

The CMS process has been found to require different ratios of the CuZn and alumina in the feedstock, compared to the required ranges of the protective composition according to the invention, when deposited on the marine body. Without being bound by theory, one explanation is that the density of Cu particles is greater than Zn and alumina, which means they have more kinetic velocity on impact with the substrate and more likely to deform plastically—high density leads to preferential deposition in cold spray process.

Alumina particles cannot deform due to their very high hardness so a majority of them bounce off, some get imbedded in the soft metal matrix.

### EXPERIMENTAL

An example method of preparation is provided. The compositions, as shown in Table 2, below, were deposited on low-carbon steel (S275-J2) panel size 200×100×3 mm. The panels were grit blasted to grade Sa 2% (ISO 8501-1) with surface roughness aimed at >70 μm (Rₜ). The coatings were applied using an automated X-Y scanner. The required coating thickness was achieved with three consecutive passes of the spray gun (raster on the substrate surface), details of the deposited LP-CMS coating test samples and main process parameters are summarised in below table. Three blends of feedstock powders were used for depositing three different example compositions:
composition 1 feedstock powder−Cu (balance)/Zn 30 wt. %/Al₂O₃ 15 wt. %, (provides final composition inclusion of 1% wt Al₂O₃)
composition 2 feedstock powder−Cu (balance)/Zn 30 wt. %/Al₂O₃ 30 wt. %, (provides final composition inclusion of 3% wt Al₂O₃), and
composition 3-feedstock powder−Cu (balance)/Zn 30 wt. %/Al₂O₃ 45 wt. %, (provides final composition inclusion of 5% wt Al₂O₃)

TABLE 2
composition and process parameters

| Process Parameters | Composition 1 | Composition 2 | Composition 3 |
|---|---|---|---|
| Input air pressure (bar) | 5.6 | 5.6 | 5.6 |
| Spray gun temperature (° C.) | 300-400 | 400-500 | 400-500 |
| Powder feed rate (g s⁻¹) | 0.6 | 0.6 | 0.6 |
| Nozzle material/cross-section/ | Stainless steel/ | Stainless Steel/ | Ceramic/ |
| diameter (mm) | Round/5 | Round/5 | Round/5 |
| Nozzle transverse speed, X- | 3-6 | 3 | 3-6 |
| axis (cm s⁻¹) | | | |
| Nozzle step over, Y-axis (mm) | 3 | 3 | 3 |
| Nozzle stand-off distance, Z- | 10 | 10 | 10 |
| axis (mm) | | | |
| Nozzle orientation (strike | 90° | 90° | 90° |
| angle) | | | |
| Number of passes | 3 | 3 | 3 |
| Coating thickness (mm) | 0.3 ± 0.05 | 0.3 ± 0.05 | 0.3 ± 0.05 |

It will be appreciated that the compositions of the invention are capable of being incorporated in the form of a variety of embodiments, only a few of which have been illustrated and described above.

An embodiment of the invention will now be described by way of example only and with reference to the accompanying drawings of which:—

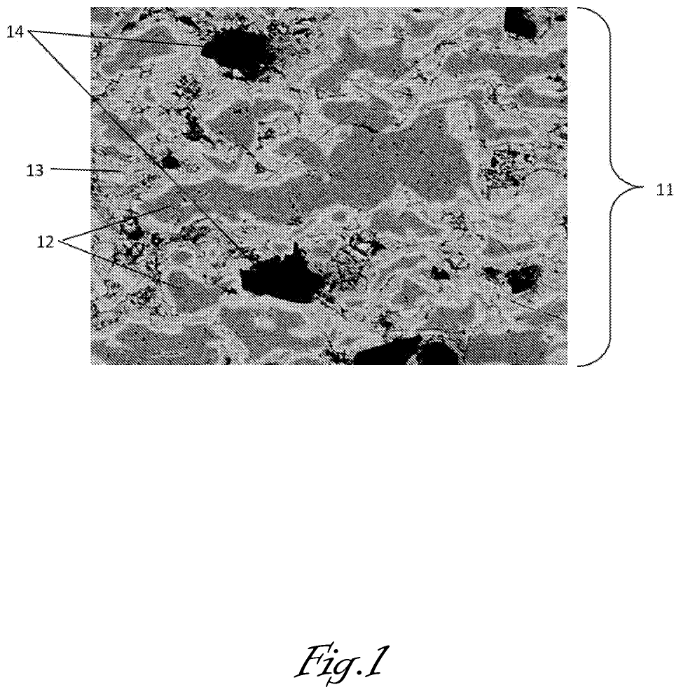

FIG. 1 shows a magnified SEM of composition 2

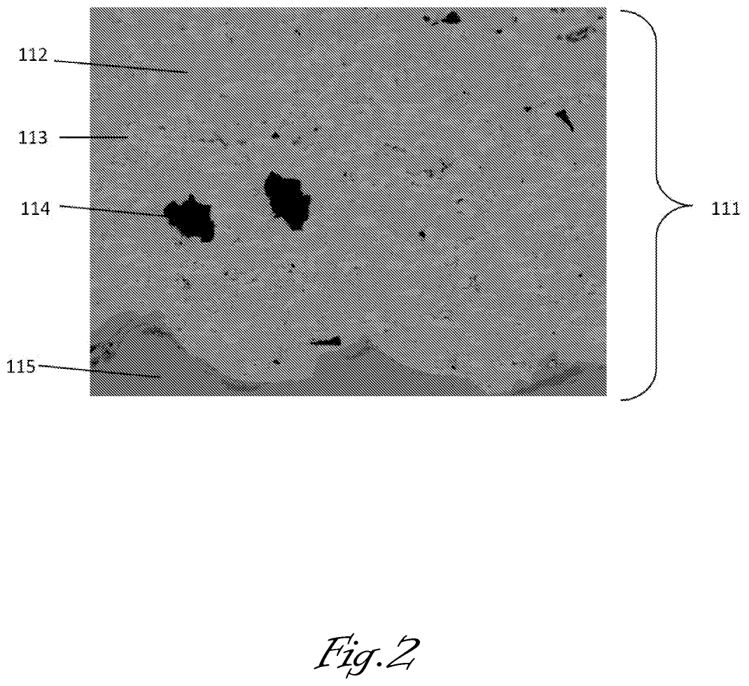

FIG. 2 shows an SEM of composition 1

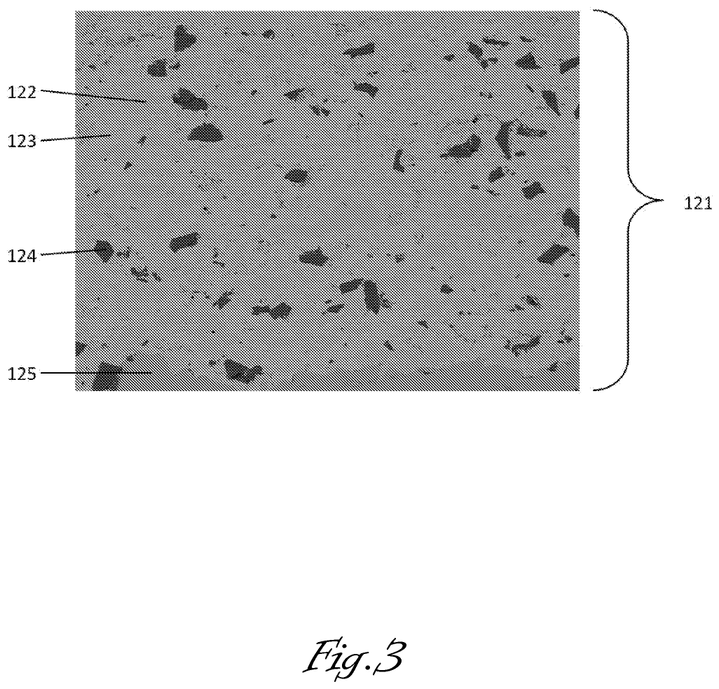

FIG. 3 shows an SEM of composition 2

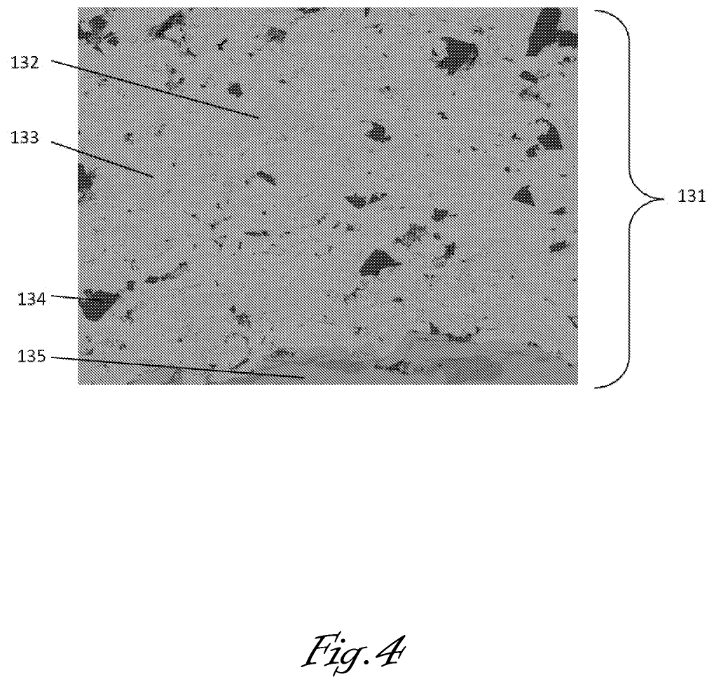

FIG. 4 shows an SEM of composition 3

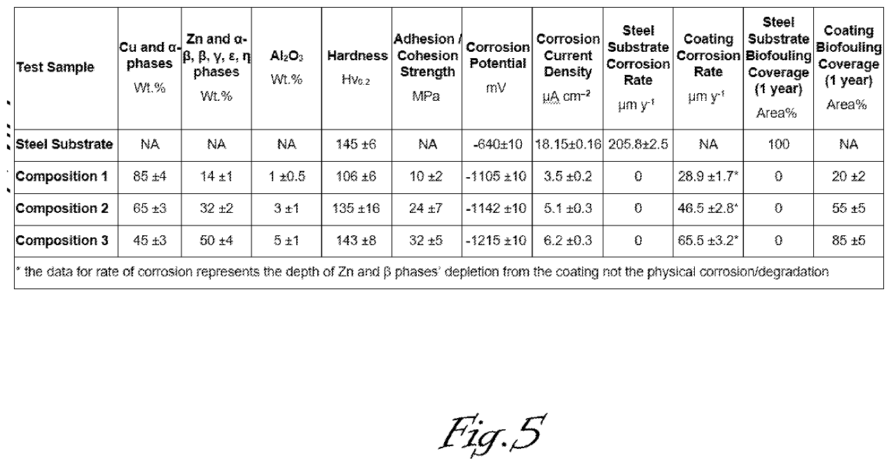

FIG. 5 shows a table of results of Compositions 1 to 3

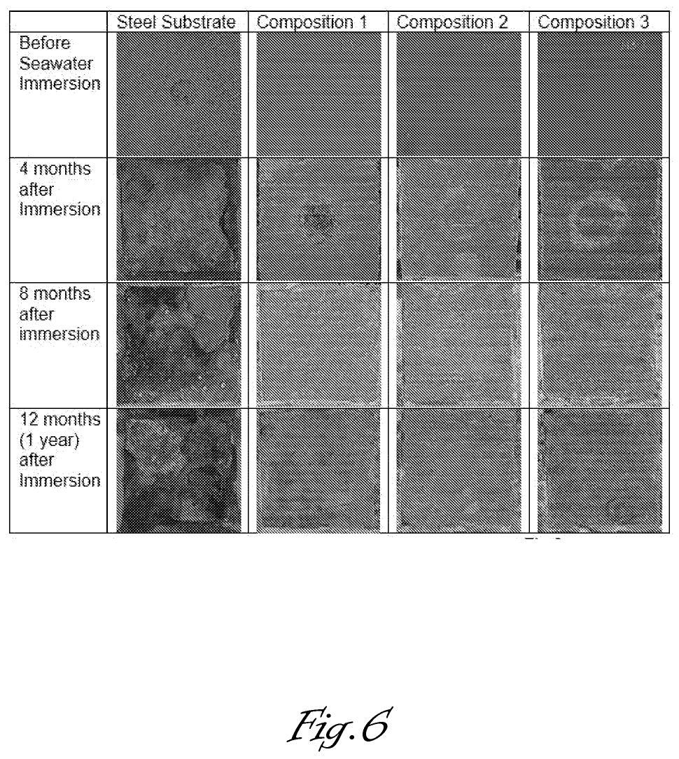

FIG. 6 shows deterioration of substrates and coated substrates post 1 year of seawater immersion

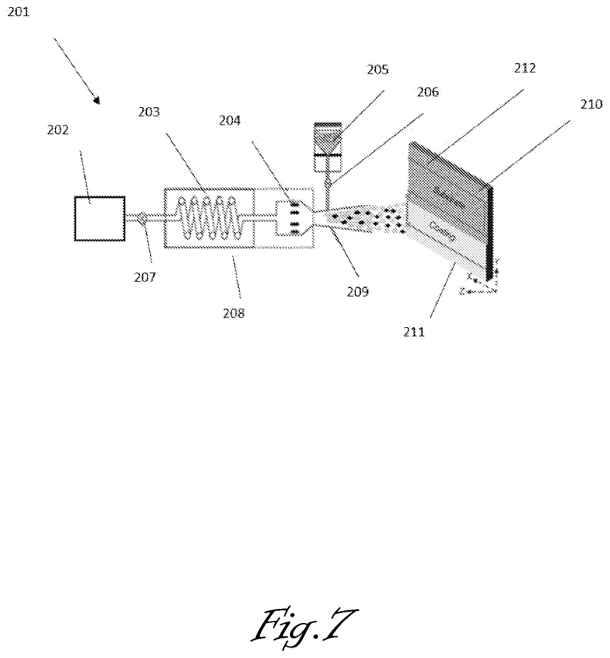

FIG. 7 shows a schematic of a cold metal spray apparatus

FIG. 1 shows a magnified image of SEM of composition 2 as indicated generally 11 wherein the distribution of Cu and α phases of CuₓM*_{y} 12, metal M* and α-β, β, γ, ε, η phases of CuₓM*_{y} 13, and ceramic fillers 14 are present.

FIG. 2 shows the SEM of composition 1 indicated generally as 111 of the invention comprising 85 wt. % of Cu and a phases 112, 14 wt. % of Zn and α-β, β, γ, ε, η phases 113, and 1 wt. % of Al₂O₃ ceramic filler particles 114.

FIG. 3 shows the SEM of composition 2 indicated generally as 121 of the invention comprising 65 wt. % of Cu and a phases 122, 32 wt. % of Zn and α-β, β, γ, ε, η phases 123, and 3 wt. % of Al₂O₃ ceramic filler particles 124.

FIG. 4 shows the SEM of the composition 3 indicated generally as 131 of the invention comprising 45 wt. % of Cu and α phases 132, 50 wt. % of Zn and α-β, β, γ, ε, η phases 133, and 5 wt. % of Al₂O₃ ceramic filler particles 134.

FIG. 5 shows the summary of mechanical, corrosion and biofouling test results of bare steel substrate and example compositions of the invention.

Hardness was measured using Shimadzu-MCT Vickers micro-hardness test machine. The polished cross-sections of the coatings were indented with a Vickers diamond indenter using 0.200 kgf (2 N) test load with a dwell time of 15 s, an average of 10 indents is considered as the representative coating hardness. Adhesion/cohesion strength of the compositions was measured as per ASTM C633 standard pull-off adhesion test. A three-electrode electrochemical cell consisting a ϕ12 mm disc working electrode of the bare substrate and compositions, a graphite counter electrode, and a silver/silver chloride (Ag/AgCl 3M KCl) reference electrode was used for potentiodynamic polarisation test performed with a Biologic VSP-1371 potentiostat. All measurements were conducted in an earthed Faraday cage at ambient room temperature, 20±3° C. The electrolyte used was 0.6 M NaCl (3.5 wt. % NaCl) neutral salt solution with pH 5.8±0.3 and dissolved oxygen (O₂) 5.6±0.7 mg L⁻¹ prepared freshly from deionised water. Potentiodynamic polarisations were performed between −400 mV to +600 mV vs. Ag/AgCl from open-circuit potential (OCP) at a potential sweep rate, dE/dt, of 0.167 mV s⁻¹. The test samples were immersed in a static 300 mL electrolyte for 1 h to achieve a pseudo-steady-state OCP before conducting polarisation tests.

The results shows that the mechanical strength of the compositions increased with the increase of Al₂O₃ and reduction of Cu and α phase intermetallics. The hardness and adhesion strength of composition 1 with 1 wt. % Al₂O₃ and 85 wt. % Cu and α phase intermetallics was measured as 106±6 Hv_{0.2} and 10±2 MPa, respectively. The hardness and adhesion strength for composition 2 and composition 3 with respective Al₂O₃ content of 3 wt. % and 5 wt. %, and a phase intermetallics of 65 wt. % and 45 wt. %, increased to 135±16 Hv_{0.2}/24±7 MPa and 143±8 Hv_{0.2}/32±5 MPa, respectively. The corrosion rate of the example compositions shows an opposing trend, i.e. the corrosion rate slightly increases with the increase of Al₂O₃ particles and reduction of Cu and α phase intermetallics. Composition 1 has the lowest corrosion rate of 28.9±1.7 μm/y. It increases to 46.5±2.8 μm/y and 65.5±3.2 μm/y, respectively for composition 2 and composition 3. The corrosion rate of all three compositions is an order of magnitude less compared to the bare steel substrate which corroded at a rate of 205.8±2.5 μm/y. The compositions also show more electronegative potentials −1105±10 mV, −1142±10 mV and −1215±10 mV, respectively, for composition 1, composition 2, and composition 3. In comparison the corrosion potential of bare steel substrate was −640±10 mV, meaning that all compositions will offer sacrificial corrosion protection to the steel substrate in marine environment.

FIG. 6 shows the visual appearance of steel substrate and example compositions during one year long natural seawater immersion test with measurement periodicity of 4 months. The visual appearance of the test samples further validates the corrosion protection of the compositions discussed earlier. The steel substrate showed the worst corrosion appearance which worsened with the passage of time, conversely the compositions showed no physical material degradation of the composition surface. A controlled and active dissolution of Zn to Zn(OH)₂ sealed the surface of the coatings and protected the steel substrate on which these compositions were applied to. Additionally, the self-polishing nature of the example compositions presented Cu rich surface to the marine environment, which protected against biofouling attachment on to the coating surface. The area extent of the biofouling is shown in FIG. 5 table. In comparison, the surface of the bare steel substrate showed heavy biofouling. Within the composition, the composition 1 with 1 wt. % Al₂O₃ and 85 wt. % Cu and α phase intermetallics showed the cleanest and more pristine surface, (lowest biofouling coverage % area in FIG. 5 table) further validating the excellent corrosion and antifouling credentials of this composition. In addition to self-polishing, the compositions also showed self-healing functionality. The results show that the composition can actively protect the substrates from corrosive and biofouling marine environment for long-term (>20 years), which the current state-of-the-art paint based coatings cannot.

FIG. 7 shows a cold metal spray apparatus 201, comprising a spray gun 208, with a gas heater element 203 and a carrier gas flow straightener 204. A source of compressed air 202 is controlled via a valve 207 into the heating chamber, wherein the air is forced out via a De-Laval nozzle 209. A powder feeder, feeds the powder 205 into the path of the gas flow, the powder comprising the compositions as described above. The powder 205 is then directed at a substrate 210 in a raster scan 212 to deposit a coating 211 of the feedstock powder on the substrate. The coating can be built up layerwise, with other powder, intervening or intermediary layers added. The powder 205 comprising the copper zinc alloys and ceramic particles.

1. A protective composition for a marine body, wherein said composition comprises a copper alloy of the form Cu(M*), wherein M* is at least one metal, which is more electronegative than copper, wherein said composition comprises reinforced filler particles in the range of from 0.1 wt % to 20 wt %.

2. The composition according to claim 1, wherein M* is at least one of tin, zinc, iron, cadmium, aluminium, beryllium, or magnesium, or an alloy thereof.

3. The composition according to claim 1, wherein the Cu is in a greater wt % than (M*) wt %.

4. The composition according to claim 1, wherein the reinforced filler particles are ceramic filler particles.

5. The composition according to claim 4, wherein the (M*) is present in less than 55% wt in the composition, with Cu and ceramic filler particles making up 100 wt %.

6. The composition according to claim 4, wherein the ceramic filler particles are selected from a silica, alumina, tungsten carbide (WC), silicon carbide (SiC), silicon nitride (Si₃N₄), titanium oxide (TiO₂), boron carbide (B₄C), zinc oxide (ZnO), or magnesium oxide (MgO).

7. The composition according to claim 4, wherein the ceramic filler particles are present in the range of from 0.5 wt % to 10 wt %.

8. The composition according to claim 4, wherein the ceramic filler particles have an average longest dimension of 0.1 microns to 50 microns.

9. The composition according to claim 1, which is applied to the marine body at thickness of 200 microns to 1500 microns.

10. The composition according to claim 1, wherein there is an intermediary layer between the marine body and the composition.

11. A marine vessel, vehicle or craft, comprising at least one protective composition as defined in claim 1.

12. The marine vessel, vehicle or craft according to claim 11, comprising a hull which is in permanent contact with a marine environment, the hull being at least partially coated with said composition, wherein said composition comprises: ceramic filler particles in the range of from 0.5 wt % to 10 wt %; and a copper zinc (CuZn) alloy.

13. The use of a copper alloy composition of the form Cu(M*) to provide an antifouling composition on a marine body, wherein M* is at least one metal, which is more electronegative than copper, wherein said composition comprises ceramic filler particles in the range of from 0.1 wt % to 20 wt %.

14. The method of applying to a marine body the protective composition of claim 1, wherein said composition comprises a copper alloy composition.

15. The method according to claim 14, comprising the use of cold metal spraying to apply said composition to said marine body.

16. The composition according to claim 1, wherein the reinforced filler particles have a Vickers hardness in the range of 5 GPa to 70 GPa and include one or more of silica, alumina, tungsten carbide (WC), silicon carbide (SiC), silicon nitride (Si₃N₄), titanium oxide (TiO₂), boron carbide (B₄C), zinc oxide (ZnO), magnesium oxide (MgO), diamonds, carbon nanotubes, or graphene.

17. A protective composition for a marine body, wherein said composition comprises a copper zinc alloy and reinforced ceramic or carbonaceous filler particles, wherein said composition comprises zinc in the range of from 0.1 wt % to 35 wt %, and filler particles in the range of from 0.1 wt % to 20 wt %.

18. The composition according to claim 17, wherein the filler particles are selected from a silica, alumina, tungsten carbide (WC), silicon carbide (SiC), silicon nitride (Si₃N₄), titanium oxide (TiO₂), boron carbide (B₄C), zinc oxide (ZnO), magnesium oxide (MgO), diamonds, carbon nanotubes, or graphene.

19. The composition according to claim 17, wherein said composition comprises copper in the range of greater than 65 wt %, and filler particles in the range of from 0.1 wt % to 5 wt %.

20. The composition according to claim 17, wherein said composition comprises one or more first phases and one or more second phases, and wherein the copper and the one or more first phases are present in the range of 81 wt % to 89 wt %, the zinc and the one or more second phases are present in the range of 13 wt % to 15 wt %, and filler particles in the range of from 0.5 wt % to 1.5 wt %.
